(19) United States
(12) Patent Application Publication
(10) Pub. No.: US 2006/0053041 A1
(43) Pub. Date: Mar. 9, 2006

(54) Scenario information analyzer and scenario information analyzing method

(76) Inventor: Hiroyuki Sakai, Minato-ku (JP)

Correspondence Address: AKIN GUMP STRAUSS HAUER & FELD LLP;PANASONIC, ONE COMMERCE SQUARE, 2005 MARKET STREET SUITE 2200, PHILADELPHIA, PA, 19103, US

(21) Appl. No.: 10/538,025

(22) PCT Filed: Dec. 9, 2002
(86) PCT No.: PCT/JP02/12872

§ 371 Date: Jun. 8, 2005

(51) Int. Cl. G05B 19/418

(52) U.S. Cl. 705/8

(57) ABSTRACT

An apparatus and method for analyzing scenario information are provided, which automatically calculate and produce output information such as appropriate shooting schedules. The apparatus for analyzing scenario information of the invention comprises a scenario information storage section which holds scenario information divided into scenes, a reference information storage section which holds reference information about the data included in the scenario information, a calculating section which extracts the data from the scenario information and calculates output information based on the extracted data and the reference information, and an output section which produces the output information.

### TECHNICAL FIELD

The present invention relates to an apparatus and a method for analyzing scenario information.

### BACKGROUND ART

A scenario (or “scenario information”) is prepared for production of a theatrical film, a TV drama, etc. Actors and actresses play according to the scenario, while a director renders the scenario. The scenario is divided into scenes. The scenes are offered in the order in the scenario during a live performance on a stage, but rarely shot in the order in the scenario in films, TV dramas, and the like, which may be ultimately brought into a complete series of video information. The scenes are shot on optimal dates and times and in an optimal order. The video and audio information on each shot scene (or materials) are processed and assembled through film editing or electronic editing, thereby brought into a complete film, drama, or the like (a complete package).

Customarily, veterans decide through intuition the dates on which and the order in which the scenes in the scenario should be shot. However, it is difficult to plan an optimal schedule through intuition, since enormous factors influence the shooting of the scenes in the scenario.

Persons appearing in a drama (or casts) and a staff for producing the drama (a director, cinematographers, etc.) each have charge of other work in addition to the drama. Determining the schedule of the shooting of the scenes in the drama needs to consider the schedules of the casts and the staff for other work except for the drama.

The shooting of the scenes in the drama requires arrangement and preparation of shooting equipment such as cameras and videotape recorders, properties and sets, etc. In addition, reservation of places for the shooting (locations or studios) cannot be missed.

The optimal shooting schedule causes the shooting to be finished early, and causes the cost of the shooting to be low. The poor shooting schedule causes the shooting to be delayed, and causes the cost of the shooting to be high.

The director or the like edits the films or videotapes used for the shooting while referring to the scenario, and manually decides the order in which the scenes are connected to each other.

In conventional production of films, TV dramas, and the like, rationalization of processes using computer have been limited to an editing step and the downstream steps from it. A shooting step in which shooting procedures are performed according to a scenario proceeds based on intuitions and experiences.

The present invention is aimed at providing an apparatus and method for analyzing scenario information, which automatically calculate and produce output information such as appropriate shooting schedules, based on data included in the scenario and reference information associated with the data.

### DISCLOSURE OF INVENTION

To solve the above-described problem, the present invention comprises the following configuration.

An apparatus for analyzing scenario information according to an aspect of the invention is characterized by comprising: a scenario information storage section which holds scenario information divided into scenes; a reference information storage section which holds reference information about the data included in the scenario information; a calculating section which extracts the data from the scenario information and calculates output information based on the data extracted and the reference information; and an output section which produces the output information.

The invention has an effect of realizing the apparatus and method for analyzing the scenario information which automatically calculate and produce output information such as appropriate shooting schedules, based on data included in the scenario and the reference information associated with the data.

The output information such as shooting schedules, shooting costs, a list of equipment/properties, and a list of suppliers are created on the basis of, for instance, data derived from each scene such as shooting time data, shooting place data, data for casts/staff, data for equipment/properties, data for extras, and data for suppliers, and reference information associated with these data such as schedules of the casts/staff, unit prices of the casts/staff, use schedules of shooting places, unit prices of usage charges of the places, information about access to the places, use schedules of the equipment/properties, unit prices of usage charges of the equipment/properties, information about suppliers of the equipment/properties or the extras, the number of the extras available, unit prices of the extras, budget information, and deadline information.

Thus, for instance, the time for planning the shooting schedule can be reduced, and the shooting can be finished early by following the shooting schedule provided. Further, the shooting cost can be low.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF DRAWINGS

FIG. 1 is a block diagram which shows the configuration of an apparatus for analyzing scenario information according to an example of the invention;

FIG. 2 is a flow chart of a method for analyzing scenario information according to the example of the invention;

FIG. 3 shows an example of the scenario information which is entered into the apparatus for analyzing scenario information according to the example of the invention;

FIG. 4 shows an example of reference information used by the example of the invention;

FIG. 5 shows another example of the reference information used by the example of the invention;

FIG. 6 shows an example of a shooting schedule which is the output information produced by the example of the invention;

FIG. 7 shows an example of a list of equipment/properties which is output information produced by the example of the invention;

FIG. 8 shows an example of a project cost which is output information produced by the example of the invention;

FIG. 9 shows an example of a shooting cost which is output information produced by the example of the invention; and

FIG. 10 shows an example of an editing list which is output information produced by the example of the invention.

It will be recognized that some or all of the figures are schematic representations for purposes of illustration and do not necessarily depict the actual relative sizes or locations of the elements shown.

### BEST MODE FOR CARRYING OUT THE INVENTION

The following describes a specific example of the best embodiment of the invention, referring to the drawings.

### EXAMPLE

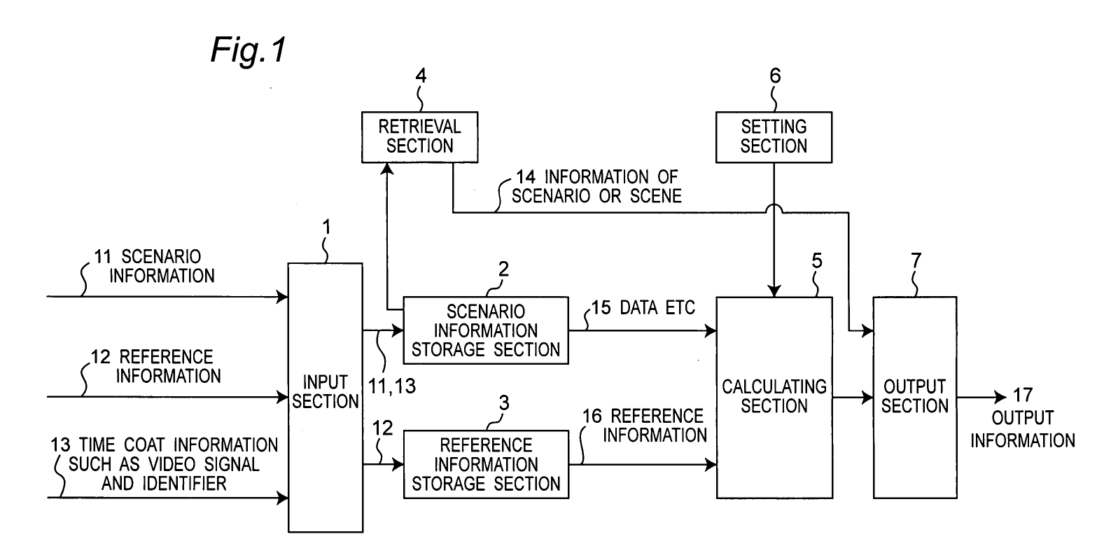

An apparatus and method for analyzing scenario information according to an example of the invention will be described with reference to FIGS. 1-10.

FIG. 1 is a block diagram which shows the configuration of the apparatus for analyzing scenario information according to the example of the invention. The numerals 1, 2, 3, 4, 5, 6, and 7 represent an input section, a scenario information storage section, a reference information storage section, a retrieval section, a calculating section, a setting section, and an output section, respectively. The typical apparatus for analyzing scenario information according to the example of the invention is a personal computer with a loaded program of the method for analyzing scenario information according to the invention.

The input section 1 receives scenario information 11 divided into scenes, reference information 12 about data included in the scenario information (or, in this example, databases from which information can be freely exploited with computers), time code information and identifiers 13 such as signals of pictures shot. The scenario information storage section 2 receives and holds the scenario information 11 and the time code information and identifiers 13 such as video signals, which are transmitted from the input section 1. The reference information storage section 3 receives and holds the reference information 12 transmitted from the input section 1. “Holding” includes storing.

The calculating section 5 receives data or the like 15 extracted from the scenario information 11 held by the scenario information storage section 2, and reads the reference information 16 associated with the data extracted from the reference information storage section 3. Based on the data and the reference information associated with the data, the calculating section 5 calculates output information. The output section 7 produces the output information 17.

The retrieval section 4 and the setting section 6 will be described later.

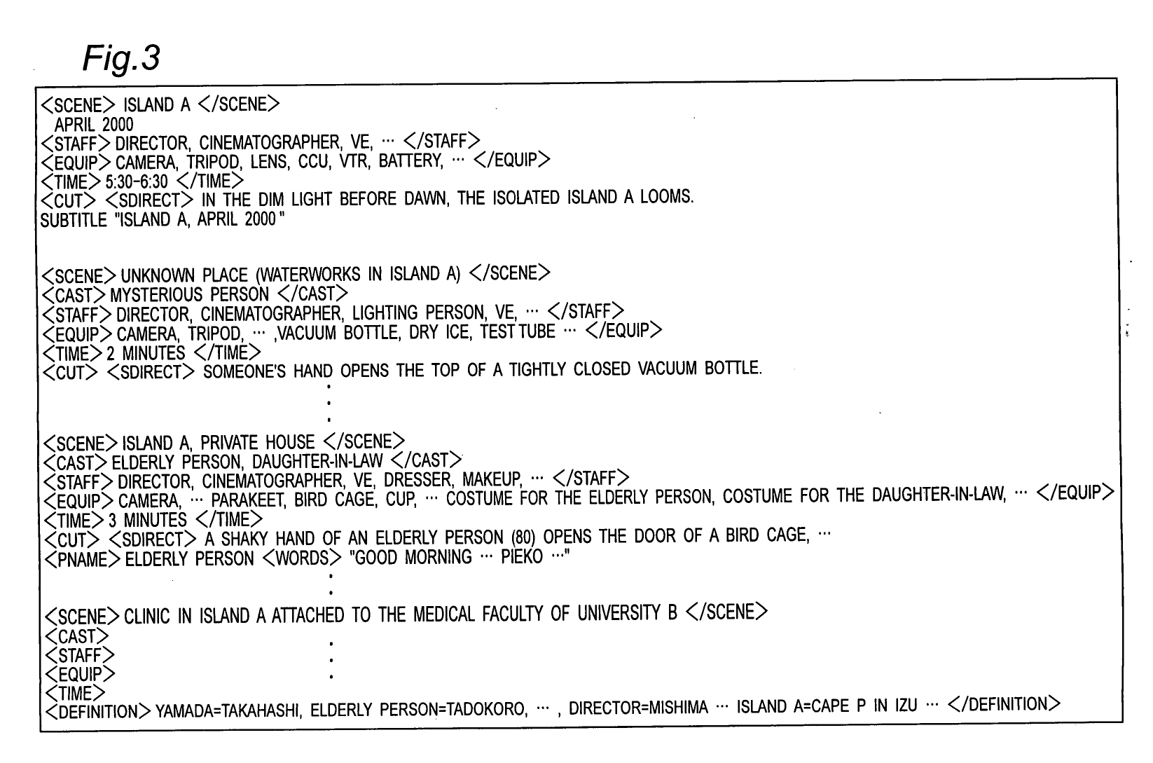

FIG. 3 shows an example of the scenario information entered into the apparatus for analyzing scenario information of the example. In FIG. 3, the scenario information is derived from each scene.

The scenario information according to the example includes identifying information. The identifying information according to the example is descriptors such as <STAFF> and </STAFF>. In the example, descriptors are expressed as sets of < > and </> or only < >. The descriptors expressed as a set of < > and </> identify a word or words put between the descriptors as one or more items of data. When two or more items of data are put in the set, the dividers between the items of data are expressed as “,”. The description put in < > denotes the type of the data identified by the descriptor.

<SCENE> and </SCENE> indicate shooting place data for each scene and identify the position of the top of each scene. Hence, the top of each scene is placed at the line including <SCENE> and </SCENE>, and the end of each scene is placed immediately before the line including <SCENE> and </SCENE> which is placed at the top of the next scene.

For instance, the data put between <CAST> and </CAST> is cast data, each item of which is expressed as the name of a character such as “elderly person”. The data between <STAFF> and </STAFF> is staff data, each item of which is expressed as the name given to a role such as “director”. The data between <EQUIP> and </EQUIP> is equipment/property data, each item of which is expressed as the name of equipment/properties such as “camera” and “flower vase”.

The data between <TIME> and </TIME> is shooting time data, each item of which is expressed as either a time length such as “2 minutes” or an interval between the start and end times such as “5:30-6:30”.

The data includes shooting time data, shooting place data, data for casts/staff, data for equipment/properties, data for extras, and data for suppliers.

The data for extras refers to data such as the number of characters to appear as extras, characteristics of the extras to appear (for instance, data specifying whether the extras are children or adults, male or female, etc.), and the like.

The data for suppliers refers to the data for the suppliers other than the staff who are present at the site of shooting, for instance, the data for suppliers of costumes, ornaments, and the like, for suppliers of cars used in the drama, etc.

<CUT> is a descriptor denoting the start of cut. <PNAME> is a descriptor denoting that it is followed by the name of a character (a cast) who is to speak his/her lines, and <WORD> is a descriptor denoting that it is followed by the lines. <SDIRECT> is a descriptor denoting that it is followed by stage directions.

<DEFINITION> and </DEFINITION> are descriptors expressing a definition, that is, denoting that one or more descriptions put between the descriptors are the definitions. When two or more descriptions (definitions) are put between the descriptors, the dividers between the definitions are expressed as “,”. For instance, “Yamada=Takahashi” defines that the actor Takahashi plays the character named “Yamada” in the scenario, “director=Mishima” defines that the director is Mishima, and “Island A=Cape P in Izu” defines that Cape P in Izu is the shooting location to be considered as Island A in the drama. The descriptors <DEFINITION> and </DEFINITION> determine who to play the characters or the roles in the scenario, thereby linking the items of the scenario information (in which data is described as the names of the character, “Yamada,” and of the role, “director”) to the items of the reference information about the data (which is information on the actor Takahashi, the director Mishima, and the like) in the database.

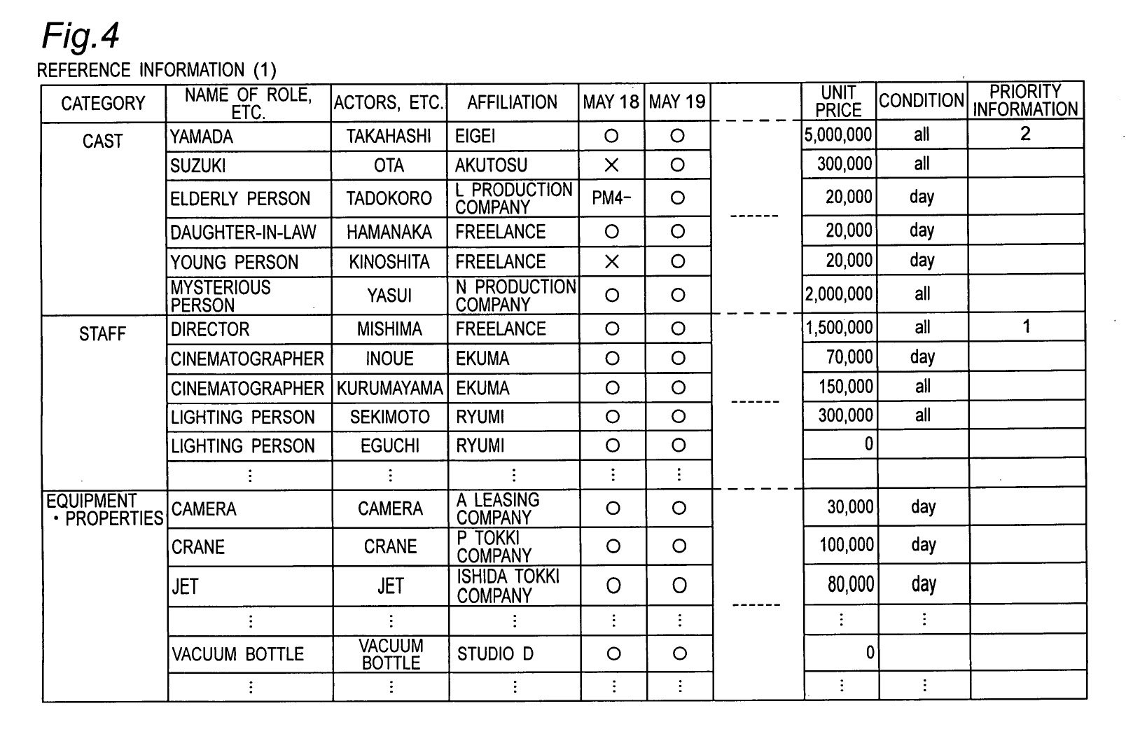

FIG. 4 illustrates a part of the database of reference information held by the reference information storage section 3. In FIG. 4, the “Category” column shows the classification of information included in the reference information (such as casts, staff, and equipment/properties).

In practice, the “Name of Role, etc.” column is not included in the reference information, but it is provided in order to facilitating the understanding of the correspondences between the data extracted from the scenario information (the “Name of Role, etc.” column) and the data included in the reference information (the “Actors, etc.” column). The definitions between the descriptors <DEFINITION> and </DEFINITION> establish correspondences between the “Name of Role, etc.” column and the “Actors, etc.” column as shown in FIG. 4.

The “Actors, etc.” column specifies the people who are to join the shooting of each scene in the scenario and the equipment/properties which are to be used for the shooting of each scene.

The “Affiliation”, “May 18”, “May 19”, . . . “Unit Price”, “Condition”, and “Priority Information” columns represent the reference information on the items described at the respective rows in the “Actors, etc.” column. The “Affiliation” column represents organizations to which the casts and the staff belong and owners of the equipment/properties (or sources such as rental services”. The “May 18” and “May 19” columns show whether the casts, the staff, the equipment/properties will be able to join (or be available for) shootings on the days. The symbol “◯” indicates that the casts, etc., will be able to join (or be available for) all-day shootings, while the symbol “x” indicates that the casts, etc., will not be able to join (or be unavailable for) shootings. The symbol “PM4-” indicates the availability for shootings from 4 p.m.

The “Unit Price” and “Condition” columns represent how much the unit costs (personnel costs, rental charges, etc.) will be required under the respective conditions. For instance, the actor Takahashi will be paid five million yen for his performance from the start to the end of shooting (indicated as “All”) regardless of the number of days when he joins the shooting. For instance, the actor Tadokoro to play the role of “an elderly person” will be paid 20,000 yen for each day when he joins shooting (indicated as “Day”).

The column for the priority information will be described later.

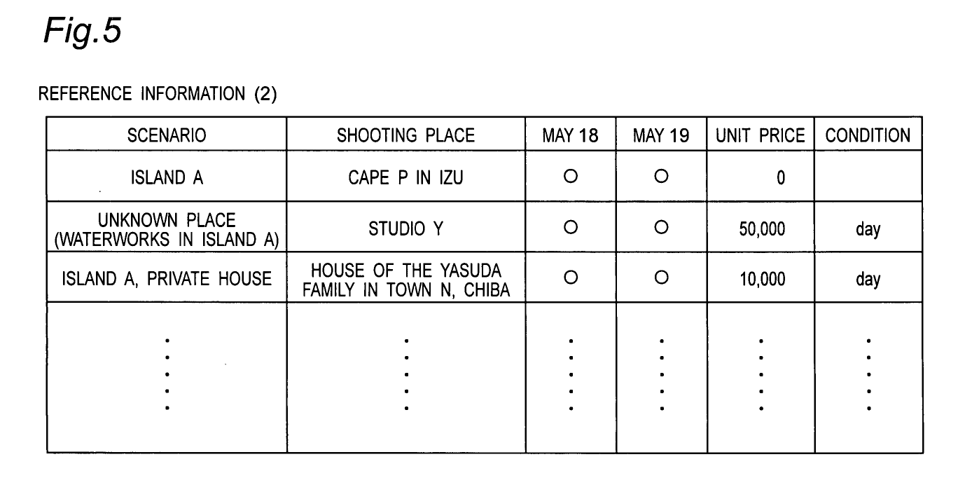

FIG. 5 illustrates another part of the database of the reference information held by the reference information storage section 3 (or shooting place data). In practice, the “Scenario” column is not included in the reference information shown in FIG. 5, but it is provided in order to facilitate the understanding of the correspondences between the shooting place data for the scenes extracted from the scenario information (shown in the “Scenario” column) and the shooting place data included in the reference information (shown in the “Shooting Place” column). In most cases, the places described in the scenario information are imaginary places, and even if a place described in the scenario information is an actual place, the place may not be the place where the shooting will be performed. Hence, it is necessary to define correspondences between the shooting place data for the scenes extracted from the scenario information (shown in the “Scenario” column) and the shooting place data included in the reference information (shown in the “Shooting Place” column). In the example, the definitions put between the descriptors <DEFINITION> and </DEFINITION> (e.g. “Island A=Cape P in Izu”) establish correspondences between the “Scenario” column and the “Shooting Place” column as shown in FIG. 5.

The “May 18”, “May 19”, . . . “Unit Price”, and “Condition” columns represent the reference information on the items described at the respective rows in the “Shooting location” column. The “May 18” and “May 19” columns represents whether the shooting places will be able to join (or be available for) shooting on the days. The symbol “◯” indicates that the shooting places will be available for all-day shooting, while the symbol “x” indicates that the shooting places will be unavailable for shooting.

The “Unit Price” and the “Condition” columns represent how much the unit costs will be required for use of the shooting places under the respective conditions. For instance, 50,000 yen is paid for each day of use of the studio Y (indicated as “Day”).

The reference information of the shooting places may include access information on the places. The “access information” is information about access to the place, which includes, for instance, the times required for travel from the place of a production office, in which the apparatus for analyzing scenario information will be used, to the shooting places, the expenses required for travel to the shooting places, and accommodation fees if lodging at the shooting places will be necessary. For instance, it is possible to go to a studio in Tokyo within one hour, while it takes five hours by car to go to Cape P in Izu. It is important to consider information about the time required for travel between the places when creating shooting schedules. The shootings at Cape P in Izu should be performed on a consecutive basis to the extent possible, thereby being able to reduce production costs.

The reference information may include deadline information of shooting (e.g. May 31, 2001) and a shooting budget (fourteen million yen in this example).

The reference information may include schedules of the casts/staff, the unit prices of the casts/staff, use schedules of shooting places, the unit prices for use of the places, access information of the places, use schedules of the equipment/properties, the unit prices for use of the equipment/properties, information of suppliers of equipment/properties or extras, the number of available extras, the unit prices of the extras, budget information, and deadline information.

The “information of suppliers of extras” is information about suppliers providing extras, which indicates, for instance, that a company M (which is a supplier of extras) can provide extras for shooting in the Kanto area but can not provide extras for shooting in other regions, that a company N (which is another supplier of extras) can not provide extras unless requested three days or more before the day when extras will be required, etc.

The “number of available extras” is information indicating that the maximum number of child extras that the company M can provide is 120, that the maximum number of extras who can ride horses that the company N can provide is 20, etc.

The “unit prices of extras” is daily or hourly wages or the like to be paid to extras or suppliers of the extras when using the extras. That is the information or the like indicating that, for instance, when using a child extra, the unit price is 5,000 yen per day.

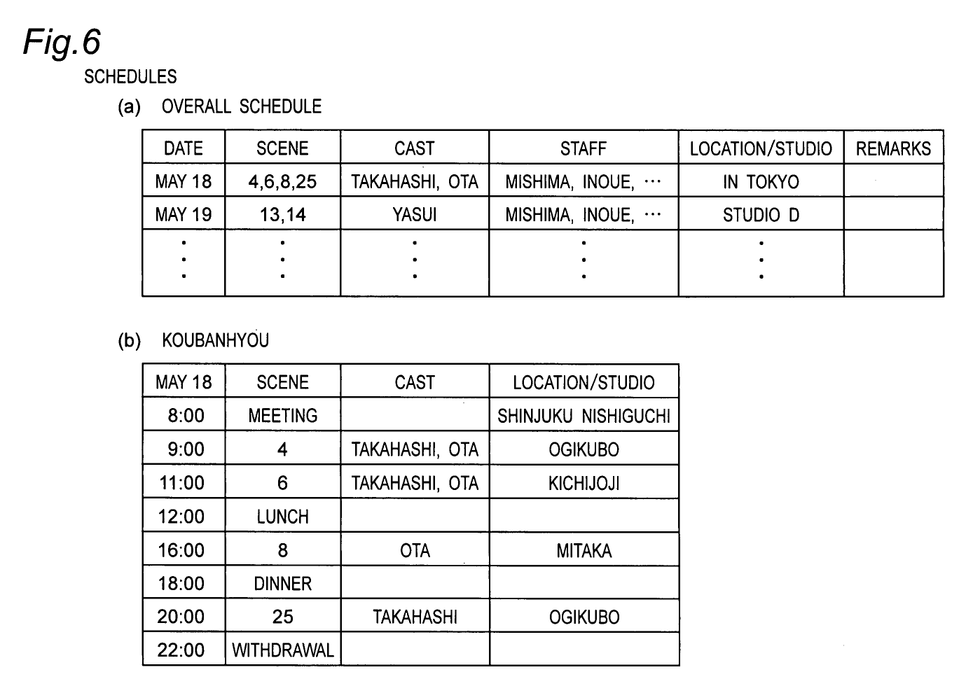

The calculating section 5 creates the output information 17 which satisfies the conditions included in the reference information 16 about the data extracted from the scenario information. FIGS. 6-10 illustrate the output information that the calculating section 5 creates.

FIG. 6 shows a shooting schedule which is an item of the output information 17. FIG. 6(a) shows an overall schedule, which indicates, for each shooting day, the numbers assigned to scenes to be shot (shown in the “Scene” column), the casts to join (shown in the “Cast” column), the staff to join (shown in the “Staff” column), and the shooting places (shown in the “Location/Studio” column).

The part (b) shows the detail of the shooting schedules for the shooting days (or koubanhyou). Although data of the staff is not included in the chart (b), the staff to join the shootings on the day will join the shootings throughout the whole period from assembling to withdrawing.

The calculating section 5 creates shooting schedules in consideration of individual schedules of the casts, the staff, the equipment/properties, and the shooting places (in other words, without conflicts with the individual schedules). The calculating section 5 creates schedules, for instance, according to which shootings of scenes at the same place will be performed on a consecutive basis, thereby making the shootings so efficient to be finished before the shooting deadline. This also adds an effect of reducing transportation and accommodation costs for the locations at remote sites such as Cape P in Izu.

In the case of the shooting places to be changed, schedules are created in consideration of travel times (or access information of each place) and times to prepare for shooting (e.g., three hours), since the preparation for shooting requires time in practice, while the duration of each scene is 20 seconds, 2 minutes, or the like.

The calculating section 5 can create shooting schedules or the like based on any reference information, and, for instance, it creates a shooting schedule based on the reference information associated with shooting time data, shooting place data, casts/staff data, and equipment data for each scene (e.g., individual schedules of the casts/staff, use schedules of the equipment, and access information of the shooting places (such as the time required for travel)).

The calculating section 5 creates shooting cost information based on the reference information associated with, for instance, shooting time data, shooting place data, casts/staff data, and equipment data for each scene (e.g., individual cost information of the casts/staff, cost information about use of the equipment, and access information of the shooting places (such as transportation and accommodation costs, etc.)).

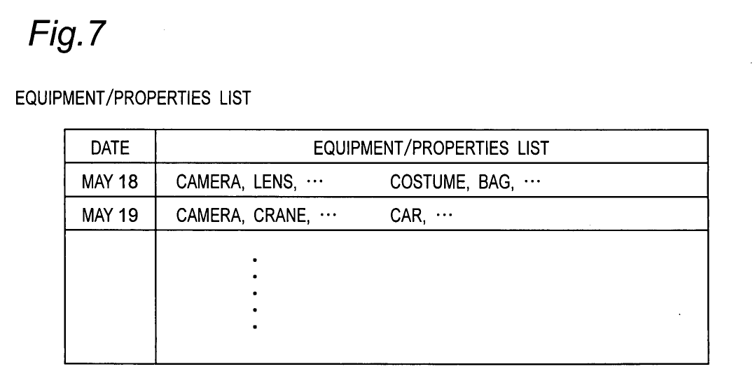

FIG. 7 shows an example of a list of equipment/properties to be prepared on each shooting day, which is an item of the output information 17. Arranging equipment/properties according to this chart, the staff can prevent failure to arrange the equipment, etc. Changes of the shooting schedules are followed by changes of the equipment and properties to be arranged, and then, the arrangement failures tend to occur. Since the calculating section 5 automatically creates the chart shown in FIG. 7, it is easy to change the schedules according to conditions during the shootings.

Halfway through the shooting period, an operator can reorganize the shooting schedule for the yet-to-be-shot scenes by entering a track record of the shootings (or the dates when the shootings were actually performed) through the setting section 6 (cf. FIG. 1). The track record is entered through putting constant values (or the dates of the shootings already performed) in parts of the shooting schedule, which is the output information of the calculating section 5. The yet-to-be-shot scenes mean the parts of the shooting schedule into which no track records of the shootings are entered.

The priority information column in FIG. 4 specifies priorities of data items for determining shooting schedules, etc. If the apparatus for analyzing scenario information cannot create a shooting schedule which satisfies all conditions, the apparatus for analyzing scenario information creates a shooting schedule while ignoring a part of reference conditions in the rows having no priority information (in FIG. 4, other than the actor Takahashi row and the director Mishima row). If the apparatus still cannot create a shooting schedule which meets the reference information described in the rows having priority information, the apparatus for analyzing scenario information creates a shooting schedule while ignoring parts of the reference conditions in the rows having priority information indicating a large value (in FIG. 4, the actor Takahashi row having the numeral “2”). Thus, when no shooting schedule and the like which satisfies all the reference conditions can be created, distinguishing the information on which importance to be placed from other information according to the priority information allows the next best shooting schedule to be created.

The calculating section 5 preferably provides a list of the conditions ignored (or the conflicts between the shooting schedule created and the individual schedules of the casts, etc.). This tells whose and which schedules have to be adjusted.

The operator can enter the priority information through the setting section 6.

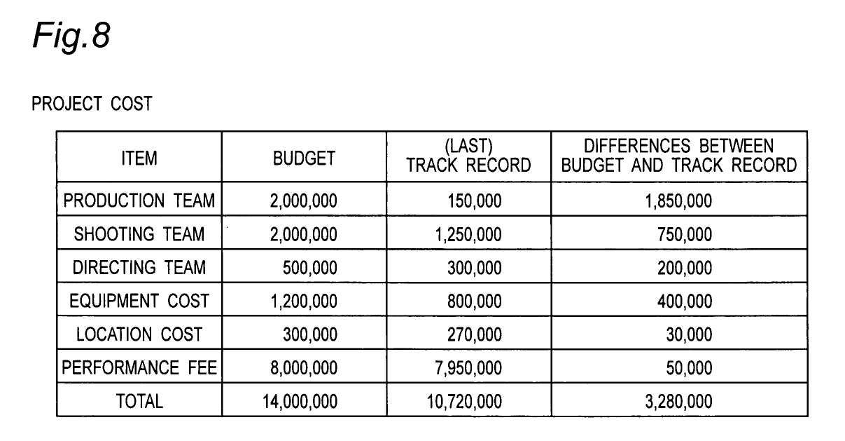

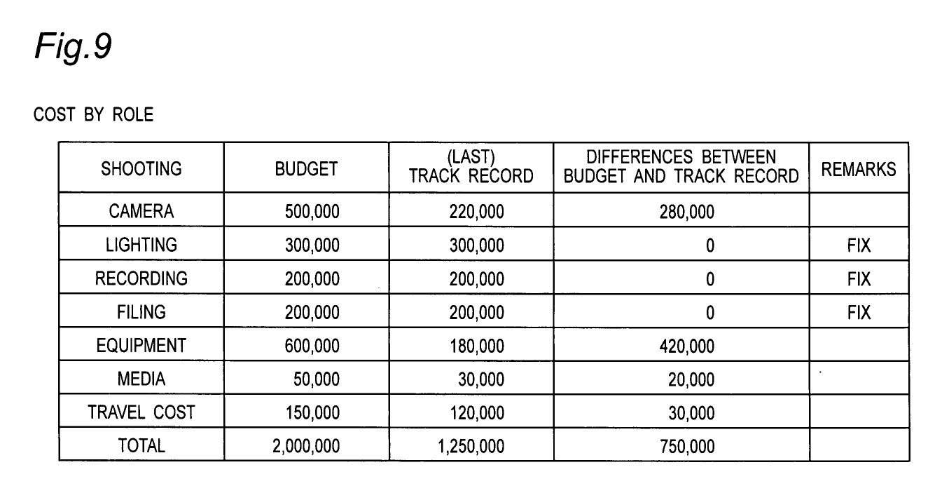

FIGS. 8 and 9 show examples of charts of project and shooting costs, respectively (the shooting cost is a part of the project cost), which are output information created by the calculating section 5. The calculating section 5, based on the above-described scenario, calculates the shooting cost, etc., and the project cost which is the sum of the costs of sections. The calculating section 5 arranges a cost plan so that a shooting cost and the like fall within a budget (which is included in the reference information).

Halfway through the shooting period (or after the completion of shootings), the operator can enter the track record of budgets into the calculating section 5 through the setting section 6 (shown in FIG. 1). The calculating section displays the track records of the current spending and the differences between the budgets and the track records, in addition to the budgets as shown in FIGS. 8 and 9.

The output information includes the shooting schedule, the shooting cost, the equipment/properties list, and the suppliers list.

For instance, when an automobile manufacturer becomes a sponsor of a drama, it is required to use in the drama the cars sold by the automobile manufacturer. The operator, through the setting section 6, assigns the automobile manufacturer's products to the cars which are parts of the properties for use, thereby allowing the sponsor's requirement to be reflected in the shootings.

In some cases, the calculating section 5 creates shooting schedules for more than one scenario. The operator enters through the setting section 6 priority information denoting which scenario information should be put on a higher priority for shooting schedules, and thereby, the calculating section 5, based on the priority information, calculates the output information on scenarios in order of priority.

The operator can enter retrieval information into the retrieval section 4. The retrieval section 4, from among many items of scenario information held by the scenario information storage section 2, retrieves the scenarios or the scenes in scenarios which include the same information as the retrieval information entered, and provides outputs information about the scenarios or the scenes in scenarios retrieved. The apparatus for analyzing scenario information provides the information about the scenarios or the scenes in scenarios.

For instance, when a scene of a drama was broadcast on TV five years after the shooting, an identification number of the scene (assuming that the identification number had been maintained in the video signal of the scene at the five-year-after broadcasting) may be used as retrieval information for retrieval of the scenario information in an electronic warehouse, and thus, the scene can be identified as which scene in which scenario. Thereby, it is easy to know who owns the copyright over the scene. It is easy to know who is the actor appearing in it. The name of the actor may be used as retrieval information for retrieval of the scenario information in the electronic warehouse, and thereby, scenes in which the actor appears can be extracted. This facilitates, for instance, making a memorial program for the tenth anniversary of the actor's debut.

In the case where the scenario information storage section 2 is a large-scale archive such as an electronic warehouse, the apparatus and method for analyzing scenario information according to the invention are especially effective, since manual retrieval is extremely difficult.

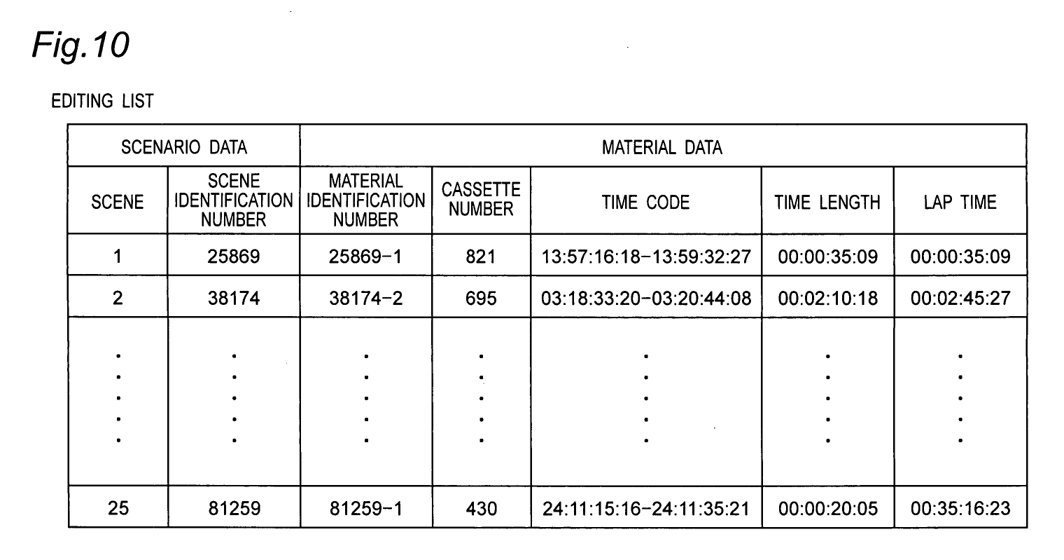

FIG. 10 illustrates an example of an editing list which is an item of the output information produced by the calculating section 5. A scene identification number is assigned to each scene in scenario information (scenes 1-25 in the example). The scene identification numbers are identifiers unique to the scenes and represented as five-digit numbers in the example.

At the shooting, a cassette number (which is any number) and a material identification number which is the same value as the scene identification number are assigned to each of the videotapes used for the shootings (materials). When two or more videos are used for the shooting of one scene, each of the videos is provided with a material identification number which is a combination of the same value as the scene identification number, a hyphen, and different figures.

The calculating section 5 arranges the material identification numbers in order, starting at the scene 1, and then creates an editing list. The editing list includes time codes, time lengths, and lap times, in addition to the material identification numbers and the cassette numbers arranged in the order of the scenes. For instance, of a time code 13:57:16:18-13:59:32:27, the part 13:57:16:18 (or 13 o'clock, 57 minutes, 16 seconds, and 18 frames) represents a time code associated with the video signal at the top of the video on which the scene is recorded, while the other part 13:59:32:27 represents a time code associated with the video signal at the end.

The “Time Length” refers to the time length of the video on each scene. The time length is obtained by subtracting the top time code from the end time code. The “Lap Time” refers to the cumulative time length of the time lengths of the respective scenes. For instance, when video signals are derived according to the editing list provided from the calculating section 5 as shown in FIG. 10, it is clear that the length of a drama is 35 minutes, 16 seconds, and 23 frames. From this, an editor (e.g., a director) can know how long the materials are to be cut out in order to derive a complete package having an appropriate length.

Using the editing list as a basis, the editor can proceed with editing.

When there are two or more materials on the same scene, the editor freely selects one video, for instance, between a video numbered the material identification number 25869-1 and another video numbered the material identification number 25869-2, and then enters the selection command into the setting section 6. The calculating section 5 creates an editing list which includes the selected video.

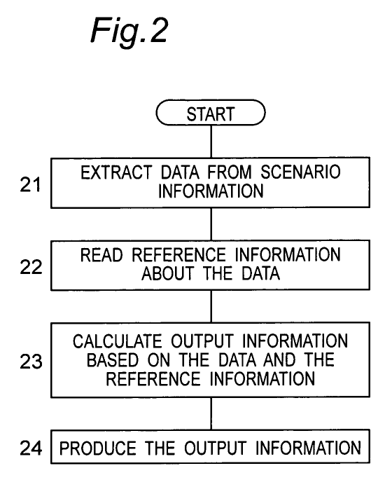

FIG. 2 is a flow chart of the method for analyzing scenario information according to the example of the invention. At first, data is extracted from scenario information (Step 21). Next, reference information on the extracted data is read (Step 22). Next, output information such as a shooting schedule and a shooting cost is calculated, based on the data and the reference information (Step 23). Next, the output information is produced (Step 24). The producing method may be a method of printing on a paper, a method of viewing on a display screen, etc.

A program for executing the flow chart of the method for analyzing scenario information according to the invention is loaded in a computer whose storage section (such as a hard disk device) holds the scenario information and the reference information divided into scenes, and then, the computer can function as the apparatus for analyzing scenario information according to the invention.

The invention achieves the effect of realizing the apparatus and method for analyzing scenario information, which, based on data included in the scenario and reference information associated with the data, automatically calculate and produce the output information such as appropriate shooting schedules.

This can, for instance, reduce the time to arrange the shooting schedules, and further, shootings can be quickly finished when performed according to the shooting schedules produced. The shooting cost can be low.

Adding the priority information to the reference information enables to create the shooting schedule according to which the shootings are performed in very short unoccupied periods (which is included in the reference information) of a popular actor (with a high priority) whose personal schedule cannot be easily changed and include few unoccupied periods.

In this case, for instance, parts of the schedules (included in the reference information) of the ordinary staff (with low priorities) may be ignored. When parts of the schedules of the ordinary staff are ignored, it is preferably noted that a list of the parts ignored (or the parts causing the conflicts between the individual schedules of the staff and the shooting schedules) is to be produced, and thereby, the parts causing the conflicts have to be adjusted.

For instance, when an automobile manufacturer sponsors a drama, it is preferable that all cars to appear in the drama are products of the automobile manufacturer. In this case, even if cars made by a plurality of automobile manufacturers have been registered in the reference information (which is preferably registered in the form of a database) (which, in other words, allows any cars to be used for the shootings), data is fixed at the products of the sponsoring automobile manufacturer.

When the shootings start after the initial determination of the schedule, the track records of the shooting schedules, the shooting costs, etc., are posted. Setting the products of the sponsoring automobile manufacturer or the track records as fixed values allows automatically creation of the shooting schedules or the like which are revised using the track records as the preconditions and the like.

Two or more scenarios to which priority information has been added are entered, and accordingly, when competing for the desired dates of use of a studio, for instance, the right to use the studio on the date is given to the scenario having a higher priority (such as the scenario which has an earlier deadline for delivery of a complete package than the other scenarios). In this manner, shooting schedules or the like can be optimized for all the studios where the shootings of the two or more scenarios proceed in parallel.

The apparatus and method for analyzing scenario information according to the invention can store scenario information in an electronic warehouse and, based on retrieval information, can retrieve the equivalent included in the scenario information. For instance, when a scene of a drama was broadcast on TV five years after the shooting, an identification number of the scene (assuming that the identification number had been maintained in the video signal of the scene at the five-year-after broadcasting) may be used as retrieval information for retrieval of the scenario information in the electronic warehouse, and thus, the scene can be identified as which scene in which scenario. Thereby, it is easy to know who owns the copyright over the scene. It is easy to know who is the actor appearing in it. The name of the actor may be used as retrieval information for retrieval of the scenario information in the electronic warehouse, and thereby, scenes in which the actor appears can be extracted. This facilitates, for instance, making a memorial program for the tenth anniversary of the actor's debut.

Conventionally, a director or the like edits, in the order manually determined, the materials such as films and videotapes used for the shootings. The apparatus and method for analyzing scenario information according to the invention receives time code information or the like and identifiers (unique information assigned to each scene in the scenario information) of the materials, and then creates and produces an editing list which shows the materials automatically edited in the order of the scenes in the scenario information. This allows an editor (such as a director) to start editing operation using as a basis the editing list whose items are connected in their order in the scenario. Usual editing operations are performed on a scenario basis or while considering which parts of the scenario to be changed. Since many materials are provided just as arranged in their order in the scenario, it is easy to retrieve the scenes that one wants to watch. The apparatus and method for analyzing scenario information according to the invention can realize the rationalization of not only shooting steps but also the downstream steps.

The above-described disclosure of the invention in terms of the presently preferred examples is not to be interpreted as intended for limiting. Various alterations and modifications will no doubt become apparent to those skilled in the art to which the invention pertains, after having read the disclosure. As a corollary to that, such alterations and modifications apparently fall within the true spirit and scope of the invention. Furthermore, it is to be understood that the appended claims be intended as covering the alterations and modifications.

### INDUSTRIAL APPLICABILITY

The apparatus and method for analyzing scenario information according to the invention are useful for producing commercial films, such as movies, TV programs and commercials, etc., and radio programs with higher efficiency.

1. An apparatus for analyzing scenario information, comprising:
a scenario information storage section in which holds scenario information divided into scenes;
a reference information storage section which holds reference information about the data included in said scenario information;
a calculating section which extracts said data from said scenario information and calculates output information based on said data extracted and said reference information; and
an output section which produces said output information.

2. The apparatus for analyzing scenario information of claim 1, wherein said data includes at least one of shooting time data, shooting place data, data for casts/staff, data for equipment/properties, data for extras, and data for suppliers, which are derived from each scene.

3. The apparatus for analyzing scenario information of claim 1, wherein said reference information includes at least one of schedules of casts/staff, unit prices of the casts/staff, use schedules of shooting places, unit prices of usage charges of the places, information about access to the places, use schedules of equipment/properties, unit prices of usage charges of the equipment/properties, information about suppliers of the equipment/properties or extras, the number of the extras available, unit prices of the extras, budget information, and deadline information.

4. The apparatus for analyzing scenario information of claim 1, wherein said output information includes at least one of shooting schedules, shooting costs, a list of equipment/properties, and a list of suppliers.

5. The apparatus for analyzing scenario information of claim 1, wherein
said reference information storage section holds said reference information to which added priority information, and
when being unable to create output information which satisfies all of the requirements of said reference information, said calculating information calculates said output information based on said data extracted and said reference information from which said reference information having a low priority has been excluded on the basis of said priority information.

6. The apparatus for analyzing scenario information of claim 1,
further comprising a setting section which sets parts of said output information to be fixed values, and
wherein said calculating section extracts said data from said scenario information, and, based on said data extracted and said reference information, calculates output information other than said output information set to the fixed values.

7. The apparatus for analyzing scenario information of claim 1, wherein
said scenario information storage section holds scenario information of a plurality of scenarios to which priority information is added, and said calculating section calculates said output information about the scenarios in order of priority, based on said priority information.

8. The apparatus for analyzing scenario information of claim 1,
further comprising a retrieval section,
wherein said retrieval section retrieves from said scenario information storage section a scenario or a scene in a scenario which includes the same information as retrieval information received, and produces the information of the scenario or the scene in the scenario retrieved.

9. The apparatus for analyzing scenario information of claim 8, wherein said retrieval information is one or a combination of shooting time data, shooting place data, data for casts/staff, data for equipment/properties, data for extras, and data for suppliers.

10. The apparatus for analyzing scenario information of claim 1,
further comprising an input section which receives time code information of a video or audio signal of each shot scenes or an identifier of the scene,
wherein said scenario information storage section holds said identifier associated with the scenes of said scenario information,
based on said time code information and said identifier received, said calculating section creates an editing list created according to the order of the scenes in the scenario, and
said output section produces said editing list.

11. The apparatus for analyzing scenario information of claim 1, wherein said calculating section detects identifier information for each data included in said scenario information and extracts the information specified based on said identifier information as data relating to the identifier information.

12. A method for analyzing scenario information, comprising the steps of:
extracting data from scenario information divided in to the scenes;
reading reference information about said data from a reference information storage part;
calculating output information based on said data and said reference information; and
producing said output information.

13. A program of a method for analyzing scenario information which makes a computer, whose storage section holds scenario information and reference information divided into scenes, function as a apparatus for analyzing scenario information, and which comprises the steps of:
extracting data from said scenario information;
reading said reference information about said data from the storage section;
calculating output information based on said data and said reference information; and
producing said output information.
